(19) United States
(12) Patent Application Publication
(10) Pub. No.: US 2015/0346762 A1
(43) Pub. Date: Dec. 3, 2015

(54) DWELL TIMERS FOR SERIAL ATTACHED SMALL COMPUTER SYSTEM INTERFACE DEVICES

(71) Applicant: LSI Corporation, San Jose, CA (US)

(72) Inventors: William K. Petty, Colorado Springs, CO (US); Gregory A. Johnson, Colorado Springs, CO (US)

(73) Assignee: LSI CORPORATION, San Jose, CA (US)

(21) Appl. No.: 14/293,130

(22) Filed: Jun. 2, 2014

(51) Int. Cl. G06F 1/14; G06F 13/42

(52) U.S. Cl. CPC G06F 1/14; G06F 13/4221

(57) ABSTRACT

Methods and structure for dwell timers in Serial Attached Small Computer System Interface (SAS) devices. An exemplary system includes a SAS end device. The SAS end device includes a physical link (PHY) operable to receive an OPEN Address Frame (OAF) from a coupled SAS device. The SAS end device also includes a controller. The controller is able to determine that the end device is presently unable to service a connection, and to wait a period of time for a dwell timer to expire. The controller is also able to service the connection by sending an OPEN_ACCEPT response if the end device becomes able to service the connection before the dwell timer expires, and to send an OPEN_REJECT (RETRY) response if the end device does not become able to service the connection before the dwell timer expires.

### FIELD OF THE INVENTION

The invention relates generally to Small Computer System Interface (SCSI) systems, and more specifically to Serial Attached SCSI (SAS) systems.

### BACKGROUND

In deeply cascaded SAS topologies, it can take substantial amounts of time to establish a connection between a target and initiator. The larger the number of intervening expanders that are placed between the target and initiator, the larger the number of links that have to be occupied in order to establish a pathway for the connection. This in turn means a longer delay between initially requesting the connection at the target and actually establishing the connection at the initiator. If an initiator is presently unable to service a connection for a target, it sends an OPEN_REJECT (RETRY) primitive to the target, causing intervening expanders to tear down the pathway that has been established for the connection. When the target retries the rejected connection request, it takes time to re-establish the pathway to the initiator. During the time that the pathway to the initiator is being re-established for the connection request, the initiator might start servicing a connection request from a different target.

### SUMMARY

Systems and methods herein provide for dwell timers at SAS end devices that help to prevent premature transmission of an OPEN_REJECT (RETRY) primitive. One exemplary embodiment is a system that includes a SAS end device. The SAS end device includes a physical link (PHY) operable to receive an OPEN Address Frame (OAF) from a coupled SAS device. The SAS end device also includes a controller. The controller is able to determine that the end device is presently unable to service a connection, and to wait a period of time for a dwell timer to expire. The controller is also able to service the connection by sending an OPEN_ACCEPT response if the end device becomes able to service the connection before the dwell timer expires, and to send an OPEN_REJECT (RETRY) response if the end device does not become able to service the connection before the dwell timer expires.

Other exemplary embodiments (e.g., methods and computer readable media relating to the foregoing embodiments) are also described below.

### BRIEF DESCRIPTION OF THE FIGURES

Some embodiments of the present invention are now described, by way of example only, and with reference to the accompanying figures. The same reference number represents the same element or the same type of element on all figures.

FIG. 1 is a block diagram of an exemplary SAS domain.

FIG. 2 is a flowchart describing an exemplary method to implement a dwell timer in a SAS device.

FIG. 3 is a block diagram illustrating components of an exemplary SAS end device.

FIGS. 4-5 are block diagrams illustrating exemplary values for programmable dwell timers of a SAS initiator.

FIG. 6 is a message diagram illustrating exemplary communications within a SAS domain.

FIG. 7 illustrates an exemplary processing system operable to execute programmed instructions embodied on a computer readable medium.

### DETAILED DESCRIPTION OF THE FIGURES

The figures and the following description illustrate specific exemplary embodiments of the invention. It will thus be appreciated that those skilled in the art will be able to devise various arrangements that, although not explicitly described or shown herein, embody the principles of the invention and are included within the scope of the invention. Furthermore, any examples described herein are intended to aid in understanding the principles of the invention, and are to be construed as being without limitation to such specifically recited examples and conditions. As a result, the invention is not limited to the specific embodiments or examples described below, but by the claims and their equivalents.

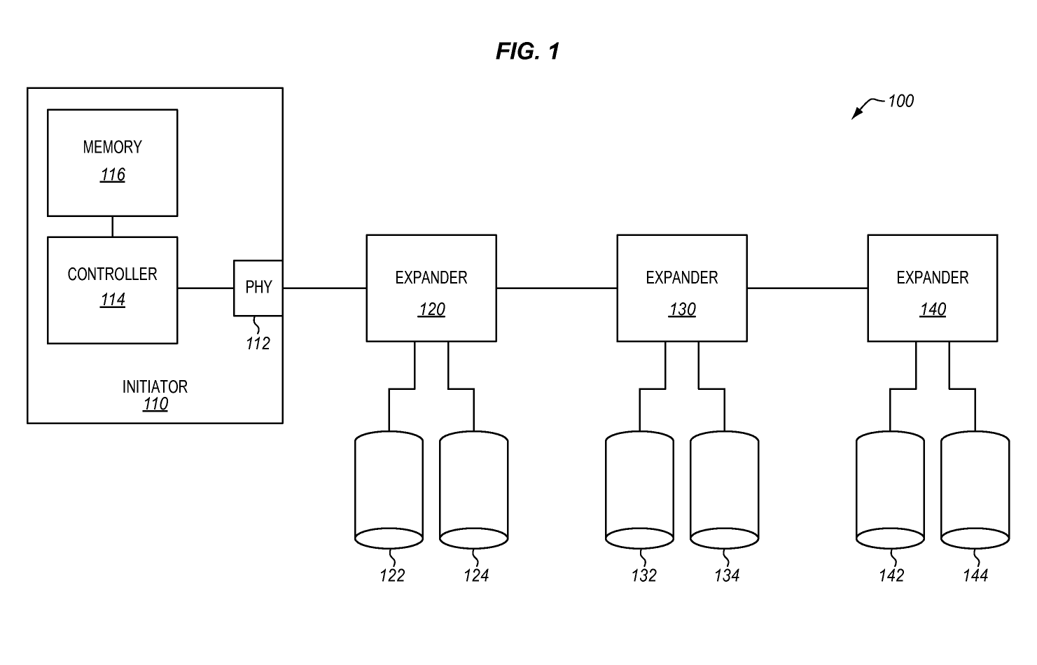

FIG. 1 is a block diagram of an exemplary SAS domain 100. SAS domain 100 establishes connections between an initiator and one or more targets in order to enable Input/Output (I/O) operations between them. In this embodiment, SAS domain 100 includes SAS initiator 110, which is coupled via expanders 120, 130, and 140 to targets 122, 124, 132, 134, 142, and 144. As used herein, initiators and targets are collectively referred to as end devices. SAS domain 100 is a cascaded topology, because individual SAS/Serial Advanced Technology Attachment (SATA) target devices are separated from initiator 110 by a potentially large number of intervening SAS expanders.

During normal operations, connections are established and/or closed between initiator 110 and the targets in order to transfer data (e.g., on behalf of a host system). After a connection has been closed (e.g., after initiator 110 sends and receives a CLOSE primitive sequence), expander 120 assumes that initiator 110 has become immediately available for servicing another connection. However, initiator 110 can still be emptying data out of a receive buffer for physical link (PHY) 112, or can otherwise be temporarily delayed (e.g., by other operations related to the connection that just closed). This means that even though the connection is closed and PHY 112 appears to be available, initiator 110 is not actually available to service incoming connection requests, such as OPEN Address Frames (OAFs). Initiator 110 could therefore respond to an OAF with an OPEN_REJECT (RETRY) primitive, even though initiator 110 has already closed its prior connection.

In general, an OPEN_REJECT (*) causes the pathway used for an OAF to be torn down. However, an OPEN_REJECT (RETRY) creates problems in a cascaded SAS domain having a large number of expanders between the initiator and the target. Specifically, in order to re-establish the pathway, each expander in the pathway re-arbitrates and re-establishes its own portion of the pathway, and these arbitration/setup delays from the expanders stack additively.

In order to prevent the substantial arbitration and setup delays resulting from OPEN_REJECT (RETRY) messages in deeply cascaded topologies, controller 114 is capable of implementing a dwell timer that prohibits PHY 112 from sending an OPEN_REJECT (RETRY) for a period of time. If initiator 110 becomes available before the dwell timer expires, an OPEN_ACCEPT is sent to the target device by initiator 110 instead of an OPEN_REJECT (RETRY), establishing the connection without the need to re-establish the pathway by the sending of another OAF.

SAS initiator 110 comprises any suitable device or component that is compliant with SAS protocols such as Serial SCSI Protocol (SSP), SATA Tunneled Protocol (STP), Serial Management Protocol (SMP), etc. For example, in one embodiment SAS initiator 110 comprises a Host Bus Adapter (HBA) that utilizes SSP to exchange host I/O with other end devices. In order to establish a connection with a target, initiator 110 utilizes a SAS port, comprising PHY 112. Initiator 110 can include further PHYs and/or ports. However, only one PHY is shown at initiator 110 in order to enhance clarity.

Controller 114 manages the operations of initiator 110, and can be implemented for example as custom circuitry, a processor executing programmed instructions stored in program memory, or some combination thereof. Memory 116 comprises any suitable system capable of storing data in a format that is accessible to controller 114 (e.g., Random Access Memory (RAM), solid state memory, etc.).

SAS expanders 120, 130, and 140 comprise any suitable devices capable of establishing connections between PHYs of end devices in accordance with SAS protocols. Specifically, each expander includes multiple internal PHYs that can be coupled with each other via switching circuitry (e.g., a crossbar switch) in order to establish connections between different SAS and/or SATA compliant devices. When multiple expanders are located between the end devices of a connection, each expander operates its switching circuitry to establish a portion of the pathway for the connection.

While three expanders are shown in FIG. 1, any number of expanders or similar routing elements can be combined to form a “switched fabric” of interconnected elements between initiators and targets in SAS domain 100. Targets 122, 124, 132, 134, 142, and 144 receive communications from the expanders of FIG. 1, and comprise any suitable SAS and/or SATA compliant devices, such as storage devices (e.g., disk drives, etc.). The particular arrangement, number, and configuration of components described herein with regard to FIG. 1 is exemplary and non-limiting.

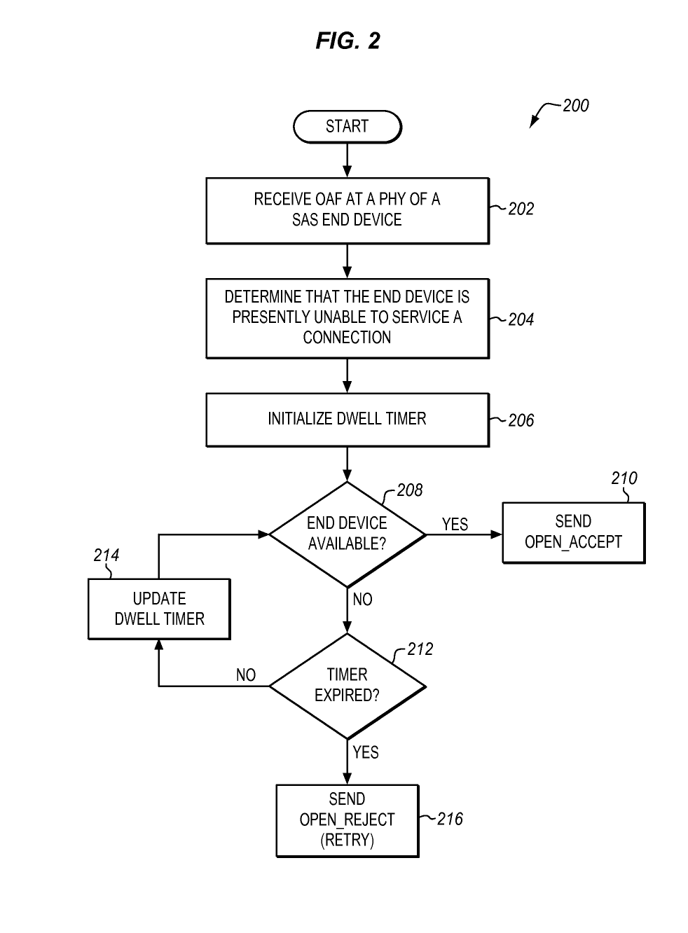

FIG. 2 is a flowchart describing an exemplary method 200 to implement a dwell timer in a SAS end device. Assume, for this embodiment, that initiator 110 has just closed a connection with target 122 via the transmission and receipt of a CLOSE primitive sequence between these devices. However, initiator 110 has not yet had time to completely clear out buffered receive data for the connection. Thus, initiator 110 is not presently able to service incoming OAFs received via expander 120. However, expander 120 concludes based on its own exchange of CLOSE primitive sequences that initiator 110 is available for another connection via PHY 112. Expander 120 then arbitrates OAFs directed to PHY 112, and transmits the OAF that wins arbitration to PHY 112.

In step 202, PHY 112 of initiator 110 receives the OAF via expander 120. The OAF is a request from a target to establish a connection with initiator 110. However, in step 204, controller 114 determines that initiator 110 is not presently able to service the connection (e.g., because the receive buffer for PHY 112 is not yet empty, or for any other suitable reason). Instead of immediately responding to the OAF with an OPEN_REJECT (RETRY) primitive, controller 114 initializes a dwell timer kept in memory 116 in step 206.

While the dwell timer is running, controller 114 checks to determine whether or not initiator 110 has become available (e.g., by emptying out the receive buffer and fully processing the data for the prior connection). If initiator 110 becomes available in step 208, then controller 114 directs PHY 112 to service the request by transmitting an OPEN_ACCEPT primitive in response to the OAF in step 210.

However, if initiator 110 has not become available, then in step 212 if the dwell timer has not yet expired, controller 114 updates the dwell timer in step 214 and returns to step 208. If the dwell timer expires in step 212 before initiator 110 becomes available, then controller 114 determines that further delay is undesirable, and it sends out an OPEN_REJECT (RETRY) primitive in step 216, resulting in the target device retrying the connection after the intervening expanders tear down the partial pathway used to transmit the OAF.

Method 200 balances undesirable delays found in cascaded topologies, because the dwell timer can give initiator 110 enough time to empty out its receive buffer before responding to an OAF. If emptying a receive buffer is preventing initiator 110 from servicing a connection, the temporary delay implemented by the dwell timer (e.g., between about 100 nanoseconds and about one microsecond) can allow an incoming OAF to be serviced. This prevents the substantial delays caused by tearing down and re-establishing a deeply cascaded connection (e.g., between about ten microseconds and about one hundred milliseconds).

Even though the steps of method 200 are described with reference to initiator 110 of FIG. 1, method 200 can be performed in other devices, such as SAS targets having their own controllers, memories, and PHYs. The steps of the flowcharts described herein are not all inclusive and can include other steps not shown. The steps described herein can also be performed in an alternative order.

### Examples

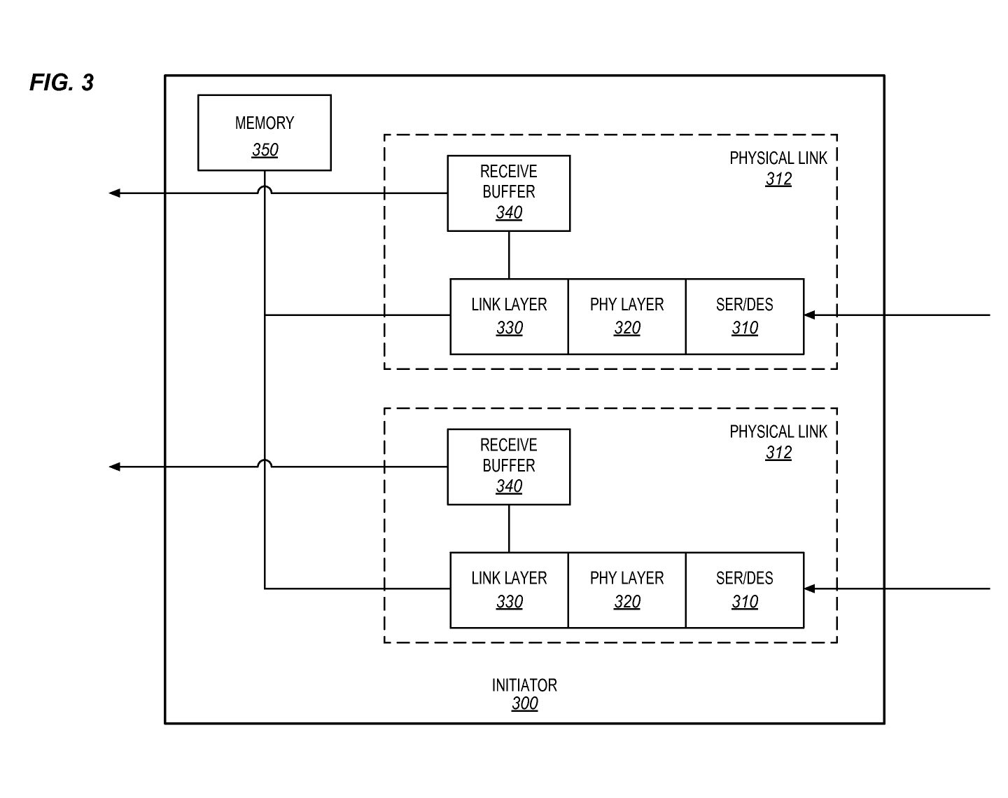

In the following examples, additional processes, systems, and methods are described with respect to dwell timers for SAS end devices. FIG. 3 is a block diagram illustrating components of an exemplary SAS end device (initiator 300). According to FIG. 3, SAS initiator 300 includes multiple physical links (PHYs) 312, and a lookup table stored in memory 350. In this embodiment, each PHY 312 includes a serializer/deserializer (Ser/Des) 310, a PHY layer 320 that operates to arrange received/transmitted data in the appropriate order, a receive buffer 340, and a link layer 330. These elements of PHY 312 include both receive and transmit paths for transferring data. A controller similar to controller 114 is implemented within each link layer 330 (e.g., as hardware circuitry) of each PHY, and therefore each link layer 330 serves to manage the overall operations of its corresponding PHY. In FIG. 3, both PHYs 312 are arranged in a ×2 (“by 2”) wide port, although other configurations for wide ports can be used if desired (e.g., ×4, ×8, ×16, ×32, etc.).

During normal operations, if initiator 300 receives an OAF at a Ser/Des 310 of a PHY 312, the link layer 330 for that PHY checks to determine if it is still busy performing operations related to a prior connection (i.e., if a receive buffer 340 for the PHY 312 is currently full). If this is the case, the link layer checks the lookup table in memory 350 (e.g., a hardware device table for initiator 300), and proceeds to identify a period for the dwell timer value.

In a further embodiment, initiator 300 includes multiple receive buffers (e.g., four receive buffers) that are used to hold four (or more) received frames from a Link Layer servicing a given connection. In such cases, a “busy” status can be detected when all of the receive buffers are full at the same time. Then, after a receive buffer becomes available again (i.e. after a received frame is processed) for that connection, the Link Layer determines that there is no longer a busy status.

The period of the dwell timer can vary based on the Arbitration Wait Time (AWT) for the received OAF, can vary based on the number of intervening expanders between the device that sent the OAF and initiator 300, or any other suitable metric. In one embodiment, the period of the dwell timer is proportional to the AWT of the received OAF. In another embodiment, the dwell timer period is maintained in a programmable register (i.e., hardware circuitry) of initiator 300 accessible to a link layer 330. Initiator 300 waits for the dwell timer to expire, sending an OPEN_ACCEPT to the target if the PHY 312 becomes available before the dwell timer expires, and otherwise sending an OPEN_REJECT (RETRY).

Thus, the dwell timer can be set based on any combination of software/firmware and/or hardware. For example, Link layer hardware/circuitry can set a dwell timer defined by a combination of flip-flops and gates (e.g., as described by a Hardware Description Language (HDL) such as Verilog Register Transfer Level (RTL)). The flip-flops and gates can implement a dwell timer setting equation such as t=a+b*(AWT)+c*(AWT)̂2, where the constants a, b, and c are determined by programmable registers, AWT is the arbitration wait time of the OAF, and t is the period of the dwell timer. In another embodiment, a dwell timer setting equation can be implemented by an equation such as t=a+b*(numExp)+c*(numExp)̂2 where constants a, b, c are determined by programmable registers, and numExp is obtained from a hardware device table that indicates the number of expanders located between the coupled device and the end device that sourced the OPEN Address Frame.

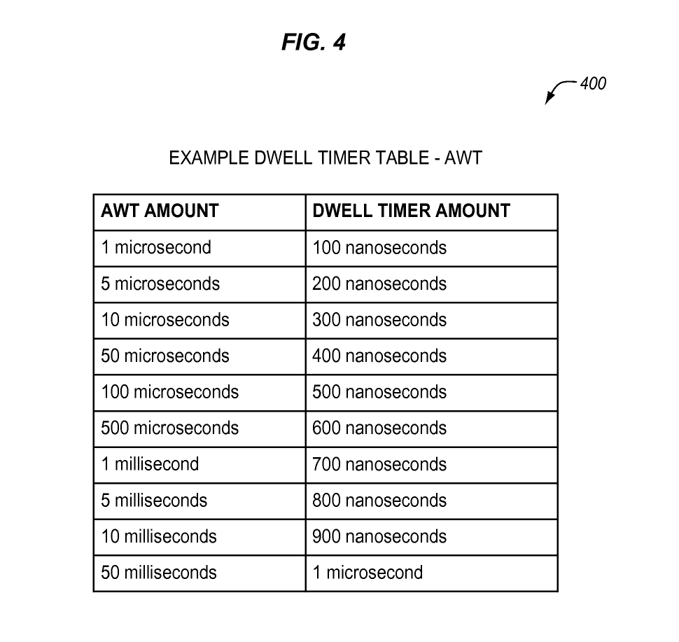

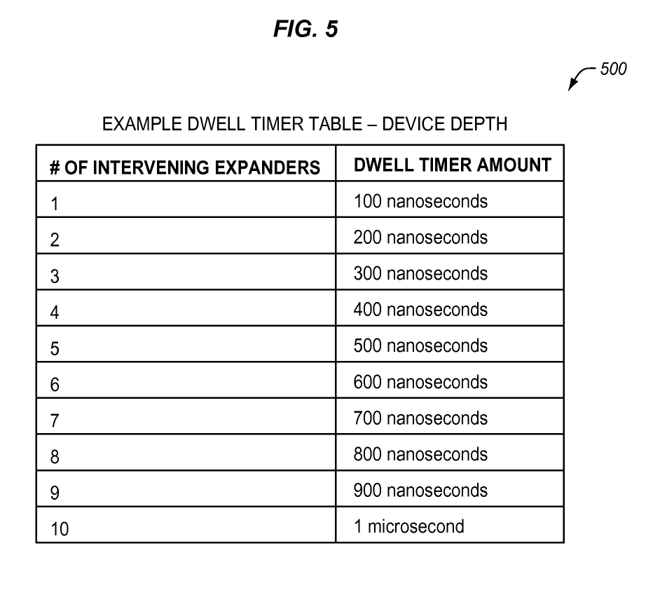

FIGS. 4-5 are block diagrams 400 and 500 illustrating exemplary values for programmable dwell timers of a SAS initiator. Specifically, block diagram 400 illustrates exemplary periods for dwell timers that are based on AWTs for OAFs, while block diagram 500 illustrates exemplary periods for dwell timers that are based on the number of intervening expanders between initiator 300 and the device that originated an OAF. The number of intervening expanders can be determined by consulting a hardware device table within memory 350 of initiator 300.

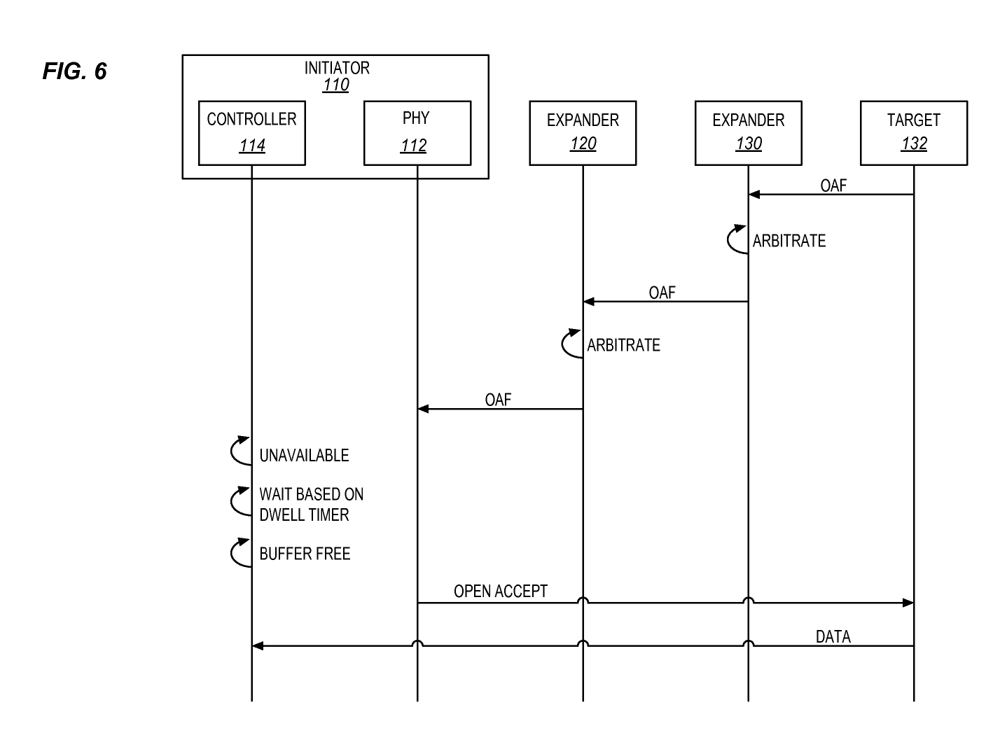

FIG. 6 is a message diagram illustrating exemplary communications within a SAS domain. According to FIG. 6, target 132 attempts to establish a connection in order to transfer data to initiator 110. Target 132 starts the process by operating a PHY to send an OAF to an internal PHY of expander 130, to which it is directly connected. Expander 130 receives the OAF, and identifies an internal PHY to route the OAF to, based on a destination address indicated in the OAF. Expander 130 then engages in arbitration to determine whether the OAF sent by target 132 should be serviced. In this example, the OAF wins the arbitration process against competing OAFs from other targets and/or expanders. Therefore, expander 130 adjusts its switching circuitry to establish an electrical link between the PHY that received the OAF and a PHY that is coupled with expander 120.

The OAF is then forwarded along to a PHY of expander 120, and expander 120 engages in its own arbitration process. The OAF wins arbitration, and expander 120 adjusts its switching circuitry to establish an electrical link between the PHY that received the OAF and an internal PHY that is coupled with initiator 110. At this point, the OAF is forwarded to PHY 112 of initiator 110. Controller 114 determines that initiator 110 is currently unavailable to service the connection requested by the OAF. However, sending an OPEN_REJECT (RETRY) would force expander 120 and 130 and target 132 to tear down the currently established partial pathway, which in turn would require target 132 to re-send an OAF and engage in the arbitration process at both expanders a second time, causing substantial delay.

To avoid this issue, controller 114 identifies a dwell timer kept in memory, and determines a length for the dwell timer (400 nanoseconds) based on the AWT of the OAF (50 microseconds). Controller 114 then waits for the length of the dwell timer. While waiting and before the dwell timer has expired, controller 114 determines that the receive buffer at PHY 112 has been cleared, thereby enabling initiator 110 to service the connection. Therefore, controller 114 directs PHY 112 to send an OPEN_ACCEPT primitive (instead of an OPEN_REJECT (RETRY)), establishing a connection with target 132, and saving target 132 from having to establish another connection.

An initiator can be unavailable for a number of reasons. For example, initiator (or even target) firmware and/or hardware can become temporarily busy when it configures or disables hardware tables needed to process a received OAF, meaning that an OPEN_REJECT (RETRY) would be sent. A dwell timer can be used in these cases to delay the sending of an OPEN_REJECT (RETRY) until the configuration is done or the tables are re-enabled.

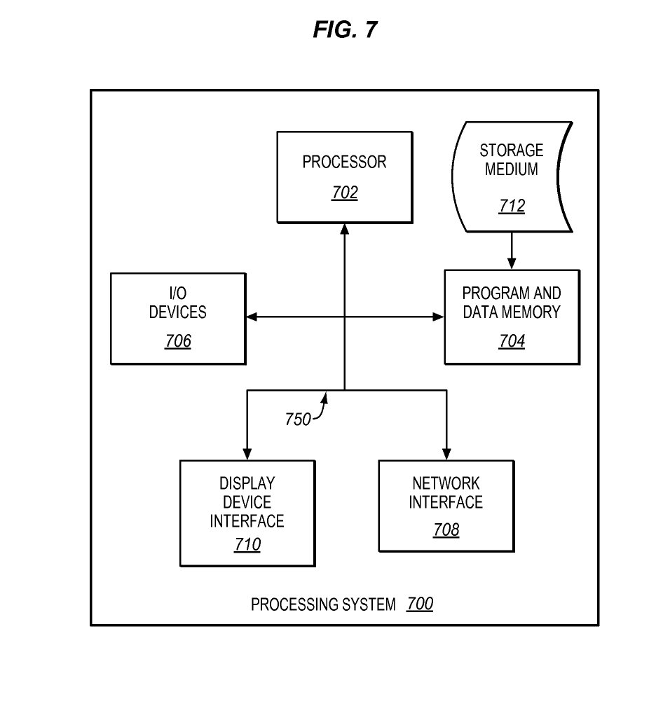

Embodiments disclosed herein can take the form of software, hardware, firmware, or various combinations thereof. In one particular embodiment, software is used to direct a processing system of a SAS end device to perform the various operations disclosed herein. FIG. 7 illustrates an exemplary processing system 700 operable to execute a computer readable medium embodying programmed instructions. Processing system 700 is operable to perform the above operations by executing programmed instructions tangibly embodied on computer readable storage medium 712. In this regard, embodiments of the invention can take the form of a computer program accessible via computer readable medium 712 providing program code for use by a computer (e.g., processing system 700) or any other instruction execution system. For the purposes of this description, computer readable storage medium 712 can be anything that can contain or store the program for use by the computer (e.g., processing system 700).

Computer readable storage medium 712 can be an electronic, magnetic, optical, electromagnetic, infrared, or semiconductor device. Examples of computer readable storage medium 712 include a solid state memory, a magnetic tape, a removable computer diskette, a random access memory (RAM), a read-only memory (ROM), a rigid magnetic disk, and an optical disk. Current examples of optical disks include compact disk-read only memory (CD-ROM), compact disk-read/write (CD-R/W), and digital video disk (DVD).

Processing system 700, being suitable for storing and/or executing the program code, includes at least one processor 702 coupled to program and data memory 704 through a system bus 750. Program and data memory 704 can include local memory employed during actual execution of the program code, bulk storage, and cache memories that provide temporary storage of at least some program code and/or data in order to reduce the number of times the code and/or data are retrieved from bulk storage during execution.

Input/output or I/O devices 706 (including but not limited to keyboards, displays, pointing devices, etc.) can be coupled either directly or through intervening I/O controllers. Network adapter interfaces 708 can also be integrated with the system to enable processing system 700 to become coupled to other data processing systems or storage devices through intervening private or public networks. Modems, cable modems, IBM Channel attachments, SCSI, Fibre Channel, and Ethernet cards are just a few of the currently available types of network or host interface adapters. Display device interface 710 can be integrated with the system to interface to one or more display devices, such as printing systems and screens for presentation of data generated by processor 702.

What is claimed is:

1. A system comprising:
a Serial Attached Small Computer System Interface end device, comprising:
a physical link operable to receive an OPEN Address Frame from a coupled Serial Attached Small Computer System Interface device;
a controller operable to determine that the end device is presently unable to service a connection, to wait a period of time for a dwell timer to expire, to service the connection by sending an OPEN_ACCEPT response if the end device becomes able to service the connection before the dwell timer expires, and to send an OPEN_REJECT (RETRY) response if the end device does not become able to service the connection before the dwell timer expires.

2. The system of claim 1, wherein:
the period of the dwell timer is based on an Arbitration Wait Time indicated in the OPEN Address Frame.

3. The system of claim 2, wherein:
the period of the dwell timer is proportional to the Arbitration Wait Time.

4. The system of claim 1, wherein:
the period of the dwell timer is between about one hundred nanoseconds and about one microsecond.

5. The system of claim 1, wherein:
the controller is further operable to review the OPEN Address Frame to identify a device that sourced the OPEN Address Frame, and to set the period of the dwell timer based on a number of intervening expanders between the end device and the device that sourced the OPEN Address Frame.

6. The system of claim 1, wherein:
the controller is further operable to identify the period of the dwell timer by consulting a programmable register at the end device.

7. The system of claim 1, wherein:
the end device further comprises a receive buffer operable to store data for the physical link; and
wherein the controller is further operable to determine that the end device is presently unable to service the connection because the receive buffer is full.

8. A method comprising:
receiving an OPEN Address Frame at a physical link of a Serial Attached Small Computer System Interface end device, wherein the OPEN Address Frame has been sent from a coupled Serial Attached Small Computer System Interface device;
determining that the end device is presently unable to service a connection;
waiting a period of time for a dwell timer to expire;
servicing the connection by sending an OPEN_ACCEPT response if the end device becomes able to service the connection before the dwell timer expires; and
sending an OPEN_REJECT (RETRY) response if the end device does not become able to service the connection before the dwell timer expires.

9. The method of claim 8, wherein:
the period of the dwell timer is based on an Arbitration Wait Time indicated in the OPEN Address Frame.

10. The method of claim 9, wherein:
the period of the dwell timer is proportional to the Arbitration Wait Time.

11. The method of claim 8, wherein:
the period of the dwell timer is between about one hundred nanoseconds and about one microsecond.

12. The method of claim 8, further comprising:
reviewing the OPEN Address Frame to identify a device that sourced the OPEN Address Frame; and
setting the period of the dwell timer based on a number of intervening expanders between the end device and the device that sourced the OPEN Address Frame.

13. The method of claim 8, further comprising:
identifying the period of the dwell timer by consulting a programmable register at the end device.

14. The method of claim 8, wherein:
the end device further comprises a receive buffer operable to store data for the physical link; and the method further comprises:
determining that the end device is presently unable to service the connection because the receive buffer is full.

15. A system comprising:
a Serial Attached Small Computer System Interface end device, comprising:
a means for receiving an OPEN Address Frame from a coupled Serial Attached Small Computer System Interface device;
a means for determining that the end device is presently unable to service a connection, waiting a period of time for a dwell timer to expire, servicing the connection by sending an OPEN_ACCEPT response if the end device becomes able to service the connection before the dwell timer expires, and sending an OPEN_REJECT (RETRY) response if the end device does not become able to service the connection before the dwell timer expires.

16. The system of claim 15, wherein:
the period of the dwell timer is based on an Arbitration Wait Time indicated in the OPEN Address Frame.

17. The system of claim 16, wherein:
the period of the dwell timer is proportional to the Arbitration Wait Time.

18. The system of claim 15, wherein:
the period of the dwell timer is between about one hundred nanoseconds and about one microsecond.

19. The system of claim 15, wherein:
the means for determining is further for reviewing the OPEN Address Frame to identify a device that sourced the OPEN Address Frame, and setting the period of the dwell timer based on a number of intervening expanders between the end device and the device that sourced the OPEN Address Frame.

20. The system of claim 15, wherein:
the means for determining is further for identifying the period of the dwell timer by consulting a programmable register at the end device.
